(19) United States
(12) Patent Application Publication
(10) Pub. No.: US 2014/0298873 A1
(43) Pub. Date: Oct. 9, 2014

(54) MODIFIED RELEASE AGROCHEMICAL COMPOSITION AND A PROCESS FOR PREPARING THE SAME

(71) Applicant: GUJARAT STATE FERTILIZERS AND CHEMICALS LTD., District Vadodara (IN)

(72) Inventors: Dinesh Harjiwanlal GARG, District Vadodara (IN); Dinesh Punamchand SHAH, District Vadodara (IN); Vinod Kantilal PATEL, District Vadodara (IN); Neelam MISHRA, District Vadodara (IN); Atanu CHAKRABORTY, District Vadodara (IN)

(73) Assignee: GUJARAT STATE FERTILIZERS AND CHEMICALS LTD., District Vadodara (IN)

(21) Appl. No.: 14/228,507

(22) Filed: Mar. 28, 2014

(30) Foreign Application Priority Data
Apr. 4, 2013 (IN) 1311/MUM/2013

(51) Int. Cl. C05G 3/00

(52) U.S. Cl. CPC C05G 3/0035
USPC 71/28

(57) ABSTRACT

The present disclosure relates to a modified release agrochemical composition and a process for preparing the same. The composition comprises cores of one or more active ingredient coated with at least one layer of hydrophobic material as a preliminary coat which is further coated with at least one layer of polyurethane based polymeric material. The layer of polyurethane is formed by in-situ polymerization of polyol and isocyanate compounds during the coating operation.

### FIELD OF THE DISCLOSURE

The present disclosure relates to agrochemicals. The present disclosure particularly relates to a modified release agrochemical composition and a process for preparing the same.

### BACKGROUND

Past agriculture system has promoted use of the agrochemicals such as pesticides, fertilizers, hormones and other chemical growth agents to boost crop yields, while neglecting their negative effects on the human health and the environment.

Among the afore-stated agrochemicals, fertilizers have been used in tremendous amount to provide essential amount of the plant nutrients for improved crop yield. These plant nutrients include nitrogen (N), phosphorus (P), potassium (K), calcium (Ca), magnesium (Mg), sulfur (S) and the like. Although, plant requires all the nutrients for its optimum growth, much of the prior art reveals use of nitrogen containing fertilizers, as plant requires nitrogen in the largest amounts for its rapid growth and it also plays a vital role in almost all plant metabolic processes.

However, when these nitrogen containing fertilizer such as urea, ammonium salts, nitrates are applied to the soil they, quickly get assimilated by various enzymes and nitrifying bacteria, and denitrifying bacteria resulting in loss of Nitrogen by nitrate leaching to aquifers, by wash outs as surface run-off due to heavy rains, or by quick release of Nitrogen containing gases or greenhouse gases. This leads to approximate 25-30% loss of applied nitrogen in the form of mono-nitrogen oxides or as nitrates.

Nitrous oxide (N₂O) formed during denitrification is an important greenhouse gas accounting for approximately 5% of the total greenhouse effect. Further, it has a lifetime of about 166 years and its Global Warming Potential is 310 time than that of carbon dioxide. N₂O is also involved in the destruction of stratospheric ozone.

To resolve this problem the prior art has focused on various techniques which can deliver controlled amounts of agrochemicals and preferably nitrogen containing fertilizers to the soil or other parts of the plant.

Currently, marketed commercial product improves utilization of nitrogen by reducing the microbial breakdown of nitrogenous fertilizers. These commercial products includes nitrification inhibitor coated fertilizers, Urease inhibitor coated fertilizers and controlled release fertilizer products. However, these products are very expensive and involve the use of hazardous chemicals.

Therefore, there is need to develop a agrochemical composition which can provide desired active in a controlled manner for a prolong period of time.

### OBJECTS

Some of the objects of the present disclosure are as follows:

It is an object of the present disclosure to provide a modified release agrochemical composition.

It is another object of the present disclosure to provide a modified release agrochemical composition which is safe and economic.

It is still another object of the present disclosure to provide a modified release agrochemical composition which provides optimum release of the agrochemicals for a prolong period of time.

It is yet another object of the present disclosure to provide a simple and economic process for preparing a modified release agrochemical composition.

It is a further object of the present disclosure to ameliorate one or more problems of the prior art or to at least provide a useful alternative.

Other objects and advantages of the present disclosure will be more apparent from the following description when read in conjunction with the accompanying drawing, which are not intended to limit the scope of the present disclosure.

### BRIEF DESCRIPTION OF THE ACCOMPANYING DRAWINGS

FIG. 1: illustrates nitrogen release and water solubility of a modified release agrochemical composition prepared as per the example 1 of the present disclosure; and

FIG. 2: illustrates nitrogen release and water solubility of a modified release agrochemical composition prepared as per the example 2 of the present disclosure.

### SUMMARY

In accordance with one aspect of the present disclosure there is provided a process for preparing a modified release composition, said process comprising the following steps:
i. providing cores consisting of granules of at least one active ingredient, said granules having size in the range of 1 mm to 20 mm; said active ingredients being selected from a group consisting of pesticides, fertilizers and herbicides
ii. coating said cores with at least one hydrophobic material having melting point in the range of 60° C. to 100° C. to obtain coated cores;
iii. forming a polymer coat on said cores by in situ polymerization of at least one polyol and at least one isocyanate in the presence of at least one catalyst to obtain polymer coated cores; and
iv. curing the polymer coated cores at a temperature ranging between 95′C and 100′C for a time period ranging between 10 and 20 minute to obtain a modified release composition.

Optionally, each of the steps ii to iv are repeated.

Typically, the process further comprises a method step of applying at least one layer of hydrophobic material on the polymer coated cores before curing.

Typically, the active ingredient is at least one fertilizer selected from the group consisting of nitrogenous fertilizers, phosphatic fertilizers and potash fertilizers.

Typically, the catalyst is at least one selected from the group consisting of stannous acetate, stannous octoate, stannous oxylate, tetra-phenyl tin, tetra-butyl tin, tri-n-butyl tin acetate, dibutyltin dilaurate, dibutyltin dioctoate, dibutyltin diacetate, 1,4-diazabicyclo[2,2,2]-octane, potassium octoate and triethylenediamine.

Typically, the hydrophobic material is at least one selected from the group consisting of petroleum wax, alpha olefin wax, polyethylene wax, paraffin wax, silicon wax, slack wax, and microcrystalline wax and the amount of said hydrophobic material is in the range of 0.1% to 2%with respect to the total mass of the active ingredient.

Typically, the polyol is at least one selected from the group consisting of diethylene glycol polyol, ethylene glycol, polypropylene glycol, organic polyols, oleo-polyols, propylene glycol, 1,4-butanediol, neopentyl glycol, 1 ,6-hexanediol, diethylene glycol, dipropylene glycol, polyethylene glycol, butanediol, neopentyl glycol, 1 ,6-heaxnediol, diethylene glycol, dipropylene glycol, polyethylene glycol, trimethylolpropane, polyether polyol, castor oil, tung oil, soybean oil, sunflower oil and linseed oil.

Typically, the isocyanate is at least one selected from the group consisting of 1 ,6-hexamethylene diisocyanate, 1 ,4-dutylene diisocyanate, 2,4-toluene diisocyanate, 2,6-toluene diisocyanate, 2,4′-diphenylmethane diisocyanate, 4,4′-diphenylmethane diisocyanate, 4,4′-diphenylpropane diisocyanate, and polymethylenepolyphenylpolyisocyanates.

Typically, the amount of polyol is in the range of 3% to 10% with respect to the total mass of the active ingredient and the amount of isocyanate is in the range of 3% to 10% with respect to the total mass of the active ingredient.

Typically, the method step (i) comprises pre-heating the granules containing active ingredient at a temperature ranging between 80° C. and 100° C.

In accordance with another aspect of the present disclosure there is provided a modified release composition comprising:
i. cores consisting of granules having particle size in the range of 1mm to 20 mm containing at least one active ingredient selected from a group consisting of pesticides, fertilizers and herbicides;
ii. at least one layer of hydrophobic material coated on said cores; and
iii. at least one coat of polymer layer on said cores wherein said polymer layer is formed by in situ-polymerization of at least one polyol and at least one isocyanate in the presence of at least one catalyst.

Typically, the polymer layer is Polyurethane.

Typically, the active ingredient is at least one fertilizer selected from the group consisting of nitrogenous fertilizers, phosphatic fertilizers and potash fertilizers.

Typically, the isocyanate is at least one selected from the group consisting of 1 ,6-hexamethylene diisocyanate, 1 ,4-dutylene diisocyanate, 2,4-toluene diisocyanate, 2,6-toluene diisocyanate, 2,4′-diphenylmethane diisocyanate, 4,4′-diphenylmethane diisocyanate, 4,4′-diphenylpropane diisocyanate and polymethylenepolyphenylpolyisocyanate and the amount of isocyanate is in the range of 3% to 10% with respect to the total mass of the composition.

Typically, the polyol is at least one selected from the group consisting of diethylene glycol, ethylene glycol, polypropylene glycol, organic polyols, oleo-polyols, propylene glycol, 1 ,4-butanediol, neopentyl glycol, 1 ,6-hexanediol, diethylene glycol, dipropylene glycol, polyethylene glycol, butanediol, neopentyl glycol, 1 ,6-heaxnediol, diethylene glycol, dipropylene glycol, polyethylene glycol, trimethylolpropane, polyether polyol, castor oil, tung oil, soybean oil, sunflower oil and linseed oil and wherein the amount of polyol is in the range of 3% to 10% with respect to the total mass of the composition

Typically, the hydrophobic material is at least one selected from the group consisting of petroleum wax, alpha olefin wax, polyethylene wax, paraffin wax, silicon wax, slack wax and microcrystalline wax and the amount of the hydrophobic material is in the range of 0.1% to 2% with respect to the total mass of the active ingredient.

### DETAILED DESCRIPTION

In recent years, the agrochemical industries have focused on developing techniques or delivery systems to deliver effective amounts of agrochemicals such as fertilizers, herbicides, pesticides and the like to the soil or other growing media. It is recognized that controlling the release of these agrochemicals to the desired target increases complete utilization of applied agrochemicals which in turn can reduce number of applications of agrochemicals and thereby reducing the cost as well.

Accordingly, the inventors of the present disclosure performed extensive experiments for controlling the release of these agrochemicals in the soil. In said experiments the inventor tried coating materials such as hydrophobic and polyurethane based polymeric materials to coat various agrochemicals in order to control the release of agrochemicals into the soil. It was surprisingly found that the agrochemicals coated with the hydrophobic material and then with polyurethane based polymeric material releases active ingredient in controlled manner for a prolong period of time.

In view of these preliminary experiments, the inventors have envisaged a modified release composition comprising cores of one or more active ingredient coated with at least one layer of hydrophobic material as a preliminary coat which is further coated with at least one layer of polyurethane based polymeric material. Typically, the layer of polyurethane is formed by in-situ polymerization of polyol and isocyanate compounds during the coating operation.

In accordance with the present disclosure cores are in the form of granules and the active ingredient present in the cores is either a hydrophilic compound or a hydrophobic compound or combinations thereof. In accordance with one of the exemplary embodiment of the present disclosure the active ingredient is a hydrophilic compound.

Typically, the active ingredient is an agrochemical which includes but is not limited to fertilizers, pesticides and herbicides. The fertilizer used in the present disclosure includes nitrogenous fertilizers, phosphatic fertilizers and potash fertilizers.

Typically, the hydrophobic material used to coat the cores containing active ingredient includes petroleum wax, alpha olefin wax, polyethylene wax, paraffin wax, silicon wax, slack wax, and microcrystalline wax.

Typically, the polyol includes diethylene glycol polyol, ethylene glycol, polypropylene glycol, organic polyols, oleo-polyols, propylene glycol, 1 ,4-butanediol, neopentyl glycol, 1 ,6-hexanediol, diethylene glycol, dipropylene glycol, polyethylene glycol, butanediol, neopentyl glycol, 1 ,6-heaxnediol, diethylene glycol, dipropylene glycol, polyethylene glycol, trimethylolpropane, polyether polyol, castor oil, tung oil, soybean oil, sunflower oil and linseed oil.

Typically, the isocyanate compound includes 1 ,6-hexamethylene diisocyanate, 1 ,4-dutylene diisocyanate, 2,4-toluene diisocyanate, 2,6-toluene diisocyanate, 2,4′-diphenylmethane diisocyanate, 4,4′-diphenylmethane diisocyanate, 4,4′-diphenylpropane diisocyanate and polymethylenepolyphenylpolyisocyanates,

In accordance with one aspect of the present disclosure there is provided a process for preparing a modified release composition.

Accordingly, in the first step, cores consisting of granules containing one or more active ingredients are first coated with a hydrophobic material to obtain coated cores. This coat ensures hydrophobicity and also imparts abrasion resistance. The hydrophobic material having melting point in the range of 60° C. to 100° C. is particularly used.

In accordance with one of the embodiments of the present disclosure cores are in the form of granules and the active ingredient includes very soluble compounds, freely soluble compounds, soluble compounds, sparingly soluble compounds, very slightly soluble compounds and slightly soluble compounds in water or combinations thereof.

TABLE 1
illustrates the solubility of the active ingredient or compound in the water.

| | Approximate volume of water for 1 |
|---|---|
| Active ingredient | part of the active ingredient |
| Very soluble compound | less than 1 part |
| Freely soluble compound | from 1 to 10 parts |
| Soluble compound | 10 to 30 parts |
| Sparingly soluble compound | from 30 to 100 parts |
| Slightly soluble compound | from 100 to 1000 parts |
| Very slightly soluble compound | from 1000 to 10,000 parts |

Typically, the hydrophobic material includes but is not limited to petroleum wax, alpha olefin wax, polyethylene wax, paraffin wax, silicon wax, slack wax, and microcrystalline wax.

In accordance with one of the embodiments of the present disclosure the active material is pre-heated at a temperature of 80° C. to 100° C. This step is required for the active ingredient having hygroscopic characteristic.

In the second step, the active ingredient having first coat of the hydrophobic material is further coated with a polyurethane based polymeric material. In this step polymer is obtained through ‘in-situ’ polymerization reaction between two highly reactive species/monomers, having multifunctional reactive groups, which in turn gets deposited on the surface of the previously coated active ingredient during the coating operations.

In accordance with the one of the exemplary embodiment of the present disclosure the aforementioned reactive species are selected from polyol and isocyanate compounds. The polymerization of polyol and isocyanate compounds is carried out in the presence of catalyst and at a temperature of 80° C. to 100° C. for a time period ranging between 2 to 5 minutes to obtain in-situ formation of a polyurethane layer. This layer provides water insoluble, abrasion resistant coatings.

Typically, the catalyst includes stannous acetate, stannous octoate, stannous oxylate, tetra-phenyl tin, tetra-butyl tin, tri-n-butyl tin acetate, dibutyltin dilaurate, dibutyltin dioctoate, dibutyltin diacetate, 1,4-diazabicyclo[2,2,2]-octane, potassium octoate, triethylenediamine and combination thereof.

In accordance with the present disclosure the method steps of coating, curing and incorporating are typically carried out using apparatus such as rotating drum, screw blender, fluidized bed, coating pan and combinations thereof.

In one embodiment rotating drum is used for coating operations. Typically, the rotating drum is operated at a speed of 20-25 rpm.

Typically, the polyol includes diethylene glycol polyol, ethylene glycol, polypropylene glycol, organic polyols, oleo-polyols, propylene glycol, 1 ,4-butanediol, neopentyl glycol, 1 ,6-hexanediol, diethylene glycol, dipropylene glycol, polyethylene glycol, butanediol, neopentyl glycol, 1 ,6-heaxnediol, diethylene glycol, dipropyleneglycol, polyethylene glycol, trimethylolpropane, polyether polyol, castor oil, rung oil, soybean oil, sunflower oil and linseed oil.

Typically, the isocyanate compound includes 1 ,6-hexamethylene diisocyanate, 1 ,4-dutylene diisocyanate, 2,4-toluene diisocyanate, 2,6-toluene diisocyanate, 2,4′-diphenylmethane diisocyanate, 4,4′-diphenylmethane diisocyanate, 4,4′-diphenylpropane diisocyanate and polymethylenepolyphenylpolyisocyanate,

The amount of polyol and the iso-cyanate compound is maintained in the range of 3% to 10% with respect to the total mass of the active ingredient.

In the third step, the active ingredient coated with hydrophobic material and polyurethane layer subjected to curing process at a temperature of 95° C. and 100° C. to obtain a modified release composition of the present disclosure.

For the curing step, contact between the coated active ingredients is minimized to avoid the coating being torn off the coated substrate and/or caves or depressions forming on a coating that may result in an uneven coating thickness. Typically, for coating of polyurethane polymer, the curing time is longer than the corresponding coating duration. Further processing parameters, such as post-stabilization temperatures and cooling times, are depend on the nature of the active ingredient to be coated and the nature of the polymer or hydrophobic material being used as the coating.

In accordance with one of the embodiments one or more layers of hydrophobic material may be further coated on the modified release composition of the present disclosure. Typically, hydrophobic material includes but is not limited to petroleum wax, alpha olefin wax, polyethylene wax, paraffin wax, silicon wax, slack wax and microcrystalline wax.

The amount of hydrophobic material is in the range of 0.1% to 2% with respect to the total mass of the active ingredient.

In accordance with yet another embodiment of the present disclosure additional coating of polyurethane based polymer may further be coated on the modified release composition.

The process disclosed in the present disclosure may be a single batch or a continuous operation. The process may be conducted in a single or multiple apparatus. Different combinations of these apparatus may also be used, such as a first rotating drum in sequence with a second rotating drum, rotating at different speeds, having different diameters or a rotating drum in co-operation with a fluid bed or a fluid bed in co-operation with a rotating drum or two fluid beds in co-operation with each other or a single fluid bed having two regions or zones, one for coating the active ingredient and the other for curing the coated active ingredient or a single rotating drum which changes its mixing power mid-operation or a single rotating drum having two regions of different diameters and the like.

In one of the embodiments of the present disclosure the apparatus is a single rotating drum, which changes its mixing power mid-operation by adjusting drum structure, such as, baffle structure and baffle angles, by using additional mechanical devices such as, a rotating mixer in the substrate bed, a comb shaped device dipped into the substrate bed or mixing bars, or by changing speed.

### EXAMPLE 1

A stainless steel insulated rotating drum having a 24 inch diameter was used to apply the coating components to the granular/prilled fertilizer. 1 kg of urea granules having a particle size range of 2.2 to 2.9 mm were pre-dried in an air circulated oven at 90° C. for two hours. Then pre-dried urea granules were fed into a rotating drum rotating at a speed of 25 rpm. The internal temperature of the drum and urea was maintained at about 90° C. using continuous flow of hot air. As a pre-coat, urea granules were coated with the 1 weight percent organic wax based on the quantity of urea taken. Once wax coating of urea is over, the coating components were added in a sequence keeping the same speed of the rotating drum and temperature at about 90° C. First 6.7 gm of castor oil was added and thereafter 13.3 gm of Methylene diphenyldiisacyanate (MDI) containing 0.3 gm of polymerization catalyst, dibutyltindilaurate, was added. During coating step the reaction temperature was maintained to 95° C. and 25 rpm of the drum. Duration of the coating step was kept for 5 minutes. At this temperature castor oil and MDI undergo ‘in-situ’ polymerization and forms polyurethane base polymer coat on the surface of the wax coated urea granules. Immediately thereafter the curing of polymer layer formed on the surface of urea was carried out at the same temperature for at least 10 minutes. During the curing step the rotating drum was operated at a speed of 10 rpm.

This procedure of coating and curing was repeated three times using the same amounts of compositions. The time period between applications of successive layers of urethane was approximately 10 minutes. The resulted polymer coated urea had four coating of polymer. After completion of four coats of polymer layers, the organic wax was used in an amount to provide a weight of 1.0 weight percent based on the weight of the urea. The speed of the drum was maintained at 10 rpm. Ten minutes after the wax was applied, the heaters for hot air were switched off and contents were cooled with a controlled stream of pressurized air to about 30° C. The total weight of the resulted modified release composition was about 1.09 kg. Thus, in this example, the sum of the urethane coat and the wax layer was 8.97 weight percent based on the weight of the urea taken. The weight of coating of total four polymer layer of polyurethane was 6.97 weight percent.

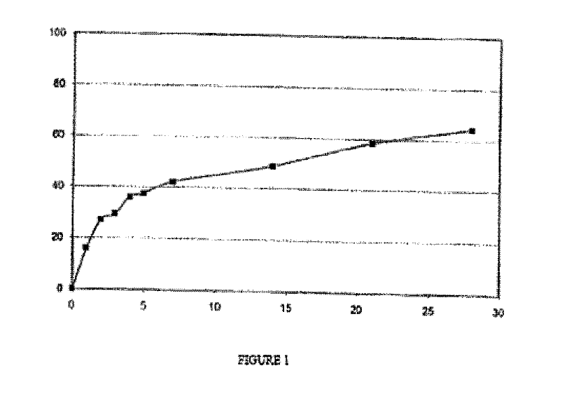

The resulted modified release composition containing urea as an active ingredient was tested for percentage nitrogen and its water release profile for the determination of controlled release properties. The nitrogen content released from aforementioned modified release composition was 41.14 weight percent on 15^{th} day (FIG. 1).

### EXAMPLE 2

The methodology in Example 1 was repeated with the exception that, polyol used in this example is a mixture of castor oil and triethanolamine in proportion of 80:20 on weight percent. In this example the total weight of the resulted modified release composition was about 1.10 kg. The sum of the urethane coat and the wax layer was 10.0 weight percent based on the weight of the urea taken. The weight of coating of total four polymer layer of polyurethane was 7.87 weight percent.

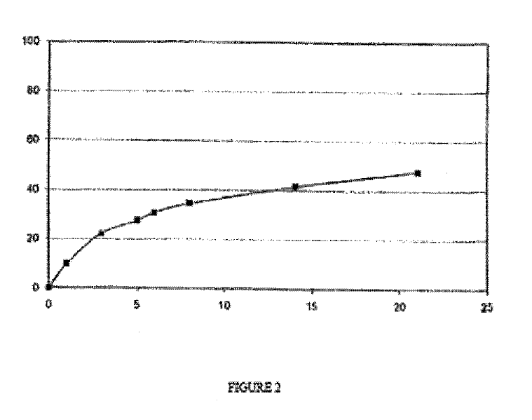

The resulted modified release composition containing urea as an active ingredient was tested for percentage nitrogen and its water release profile for the determination of controlled release properties. The nitrogen content released from aforementioned modified release composition was 40.18 weight percent on 15^{th} day (FIG. 2).

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results.

“Whenever a range of values is specified, a value up to 10% below and above the lowest and highest numerical value respectively, of the specified range, is included in the scope of the invention”.

While considerable emphasis has been placed herein on the particular features of this invention, it will be appreciated that various modifications can be made, and that many changes can be made in the preferred embodiments without departing from the principle of the invention. These and other modifications in the nature of the invention or the preferred embodiments will be apparent to those skilled in the art from the disclosure herein, whereby it is to be distinctly understood that the foregoing descriptive matter is to be interpreted merely as illustrative of the invention and not as a limitation.

1. A process for preparing a modified release composition, said process comprising the following steps:
i. providing cores consisting of granules of at least one active ingredient, said granules having size in the range of 1 mm to 20 mm; said active ingredients being selected from a group consisting of pesticides, fertilizers and herbicides ii. coating said cores with at least one hydrophobic material having melting point in the range of 60° C. to 100° C. to obtain coated cores;
iii. forming a polymer coat on said cores by in situ polymerization of at least one polyol and at least one isocyanate in the presence of at least one catalyst to obtain polymer coated cores; and
iv. curing the polymer coated cores at a temperature ranging between 95° C. and 100° C. for a time period ranging between 10 and 20 minute to obtain a modified release composition.

2. The process as claimed in claim 1, wherein each of the steps ii to iv are repeated.

3. The process as claimed in claim 1, further comprises a method step of applying at least one layer of hydrophobic material on the polymer coated cores before curing.

4. The process as claimed in claim 1, wherein the active ingredient is at least one fertilizer selected from the group consisting of nitrogenous fertilizers, phosphatic fertilizers and potash fertilizers.

5. The process as claimed in claim 1, wherein the catalyst is at least one selected from the group consisting of stannous acetate, stannous octoate, stannous oxylate, tetra-phenyl tin, tetra-butyl tin, tri-n-butyl tin acetate, dibutyltin dilaurate, dibutyltin dioctoate, dibutyltin diacetate, 1,4-diazabicyclo[2,2,2]-octane, potassium octoate and triethylenediamine.

6. The process as claimed in claim 1, wherein the hydrophobic material is at least one selected from the group consisting of petroleum wax, alpha olefin wax, polyethylene wax, paraffin wax, silicon wax, slack wax, and microcrystalline wax and the amount of said hydrophobic material is in the range of 0.1% to 2% with respect to the total mass of the active ingredient.

7. The process as claimed in claim 1, wherein the polyol is at least one selected from the group consisting of diethylene glycol polyol, ethylene glycol, polypropylene glycol, organic polyols, oleo-polyols, propylene glycol, 1 ,4-butanediol, neopentyl glycol, 1 ,6-hexanediol, diethylene glycol, dipropylene glycol, polyethylene glycol, butanediol, neopentyl glycol, 1 ,6-heaxnediol, diethylene glycol, dipropylene glycol, polyethylene glycol, trimethylolpropane, polyether polyol, castor oil, tung oil, soybean oil, sunflower oil and linseed oil.

8. The process as claimed in claim 1, wherein the isocyanate is at least one selected from the group consisting of 1 ,6-hexamethylene diisocyanate, 1 ,4-dutylene diisocyanate, 2,4-toluene diisocyanate, 2,6-toluene diisocyanate, 2,4′-diphenylmethane diisocyanate, 4,4′-diphenylmethane diisocyanate, 4,4′-diphenylpropane diisocyanate, and polymethylenepolyphenylpolyisocyanates.

9. The process as claimed in claim 1, wherein the amount of polyol is in the range of 3% to 10% with respect to the total mass of the active ingredient and the amount of isocyanate is in the range of 3% to 10% with respect to the total mass of the active ingredient.

10. The process as claimed in claim 1, wherein the method step (i) comprises pre-heating the granules containing active ingredient at a temperature ranging between 80° C. and 100° C.

11. A modified release composition comprising:
i. cores consisting of granules having particle size in the range of 1 mm to 20 mm containing at least one active ingredient selected from a group consisting of pesticides, fertilizers and herbicides;
ii. at least one layer of a hydrophobic material coated on said cores; and
iii. at least one coat of polymer layer on said cores wherein said polymer layer is formed by in situ-polymerization of at least one polyol and at least one isocyanate in the presence of at least one catalyst.

12. The modified release composition as claimed in claim 11, wherein the polymer layer is Polyurethane.

13. The modified release composition as claimed in claim 11, wherein the active ingredient is at least one fertilizer selected from the group consisting of nitrogenous fertilizers, phosphatic fertilizers and potash fertilizers.

14. The modified release composition as claimed in claim 11, wherein the isocyanate is at least one selected from the group consisting of 1 ,6-hexamethylene diisocyanate, 1 ,4-dutylene diisocyanate, 2,4-toluene diisocyanate, 2,6-toluene diisocyanate, 2,4′-diphenylmethane diisocyanate, 4,4′-diphenylmethane diisocyanate, 4,4′-diphenylpropane diisocyanate and polymethylenepolyphenylpolyisocyanate and the amount of isocyanate is in the range of 3% to 10% with respect to the total mass of the composition.

15. The modified release composition as claimed in claim 11, wherein the polyol is at least one selected from the group consisting of diethylene glycol, ethylene glycol, polypropylene glycol, organic polyols, oleo-polyols, propylene glycol, 1 ,4-butanediol, neopentyl glycol, 1 ,6-hexanediol, diethylene glycol, dipropylene glycol, polyethylene glycol, butanediol, neopentyl glycol, 1 ,6-heaxnediol, diethylene glycol, dipropylene glycol, polyethylene glycol, trimethylolpropane, polyether polyol, castor oil, tong oil, soybean oil, sunflower oil and linseed oil and wherein the amount of polyol is in the range of 3% to 10% with respect to the total mass of the composition

16. The modified release composition as claimed in claim 11, wherein the hydrophobic material is at least one selected from the group consisting of petroleum wax, alpha olefin wax, polyethylene wax, paraffin wax, silicon wax, slack wax and microcrystalline wax and the amount of the hydrophobic material is in the range of 0.1% to 2% with respect to the total mass of the active ingredient.
